(19) United States
(12) Patent Application Publication
(10) Pub. No.: US 2009/0279128 A1
(43) Pub. Date: Nov. 12, 2009

(54) IMAGE PROCESSING APPARATUS, SCREEN TRANSMISSION METHOD, AND SCREEN TRANSMISSION PROGRAM EMBODIED ON COMPUTER READABLE MEDIUM

(75) Inventor: Takashi SUGAYA, Amagasaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/331,098

(22) Filed: Dec. 9, 2008

(30) Foreign Application Priority Data
May 9, 2008 (JP) 2008-123202

(51) Int. Cl. G06K 15/10

(52) U.S. Cl. 358/1.15

(57) ABSTRACT

In order to transmit a screen in a shortened period of time, an MFP includes a request command receiving portion to receive one of a plurality of predetermined request commands from a PC, a history storing portion to store a piece of history information including the received request command, a predicting portion to determine a predicted command among the plurality of request commands based on the stored piece of history information, a predicted screen creating portion to create a predicted screen in accordance with the determined predicted command, and a transmitting portion to transmit the predicted screen when a request command received by the request command receiving portion is the same as the predicted command.

This application is based on Japanese Patent Application No. 2008-123202 filed with Japan Patent Office on May 9, 2008, the entire content of which are hereby incorporated by reference.

### BACKGROUND OF THE INVENTION

1. Field of the Invention

The present invention relates to an image processing apparatus, a screen transmission method, and a screen transmission program embodied on a computer readable medium. More particularly, the invention relates to an image processing apparatus for executing processing upon reception of control information from personal computers and the like, a screen transmission method for executing processing upon reception of control information from personal computers and the like, and a screen transmission program embodied on a computer readable medium for executing processing upon reception of control information from personal computers and the like.

2. Description of the Related Art

In recent years, it has become commonplace to connect multi-function peripherals (hereinafter referred to as MFPs) to a network and cause the MFPs to execute predetermined types of processing through personal computers (hereinafter referred to as PCs). In this regard, a technique known in the art attempts to enable the PCs to remotely operate the MFP without installing a driver program or the like for controlling the MFP by causing the MFP to act as a web server and the PCs to execute a browser program, thereby controlling the MFP. However, problems exist with processing including data aggregation on the remotely operated MFP in that receiving control information and then aggregating data elongate the period of time for data aggregation, resulting in a delayed response.

In view of this, a technique known in the art increases the processing speed by reducing data that is to be subjected to processing. For example, Japanese Laid-Open Publication No. 2002-361970 describes adding input image data a piece of identification information for registration and storing the image data in hard disk wherein a control portion collates an input user identification number and the user identification number given to the image data stored in the hard disk, and based on the collation, carries out control to display on an operation portion the name of the image data stored in the hard disk. Japanese Laid-Open Publication No. 2003-228262 describes an image forming apparatus with control means that searches for a piece of print data with identification information that matches the identification information of a piece of print data first selected from among a list of documents, renders a job of the searched print data executable, and prohibits execution of the jobs for the other pieces of print data.

Although the prior art techniques can improve the processing speed by reducing data that is to be subjected to processing, the processing itself remains unchanged, requiring a substantial period of time for response.

### SUMMARY OF THE INVENTION

The present invention is made to solve the aforementioned problems. An object of the present invention is to provide an image processing apparatus capable of transmitting a screen in a shortened period of time.

Another object of the present invention is to provide a screen transmission method capable of transmitting a screen in a shortened period of time.

Another object of the present invention is to provide a screen transmission program embodied on a computer readable medium and capable of transmitting a screen in a shortened period of time.

In order to achieve the aforementioned objects, an image processing apparatus according to an aspect of the present invention includes: a request command receiving portion to externally receive one of a plurality of predetermined request commands; a history storing portion to store a piece of history information including the received request command; a predicting portion to determine a predicted command among the plurality of request commands based on the stored piece of history information; a predicted screen creating portion to create a predicted screen in accordance with the determined predicted command; and a transmitting portion to transmit the predicted screen when a request command received by the request command receiving portion is the same as the predicted command.

According to another aspect of the present invention, a screen transmission method includes steps of: externally receiving one of a plurality of predetermined request commands; storing a piece of history information including the received request command; determining a predicted command among the plurality of request commands based on the stored piece of history information; creating a predicted screen in accordance with the determined predicted command; and transmitting the predicted screen when a request command received by the receiving step is the same as the predicted command.

According to still another aspect of the present invention, a screen transmission program embodied on a computer readable medium causes a computer to execute processing including steps of: externally receiving one of a plurality of predetermined request commands; storing a piece of history information including the received request command; determining a predicted command among the plurality of request commands based on the stored piece of history information; creating a predicted screen in accordance with the determined predicted command; and transmitting the predicted screen when a request command received by the receiving step is the same as the predicted command.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of an image processing system according to an embodiment of the present invention.

FIG. 2 is a perspective view of an MFP.

FIG. 3 is a block diagram showing an example of the hardware structure of the MFP.

FIG. 4 is a block diagram showing an example of the hardware structure of a PC.

FIG. 5 is a functional block diagram showing an example of the functions of the CPU of the MFP together with data to be stored in the HDD.

FIG. 6 is a diagram showing an example of a file list screen.

FIG. 7 is a diagram showing an example of a job list screen.

FIG. 8 is a flowchart showing an example of the flow of screen transmission processing.

FIG. 9 is a flowchart showing an example of the flow of predicted screen management processing.

FIG. 10 is a flowchart showing an example of the flow of remote operation instruction processing.

FIG. 11 is a schematic functional block diagram showing the functions of CPU 111A of MFP 100A according to a modified example of the present invention.

FIG. 12 is a flowchart showing an example of the flow of screen transmission processing according to the modified example.

FIG. 13 is a flowchart showing an example of the flow of remote operation instruction processing according to the modified example.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

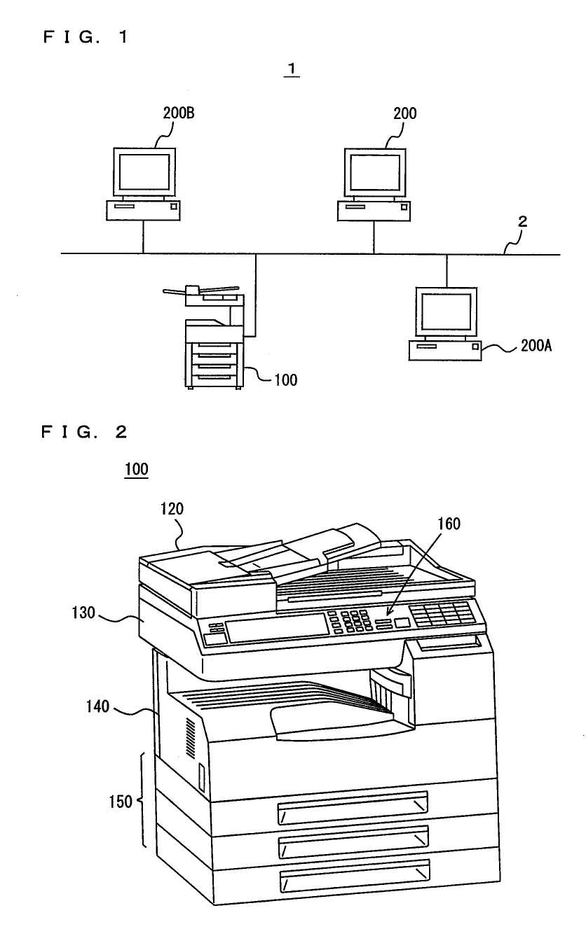

FIG. 1 is a schematic diagram of an image processing system according to an embodiment of the present invention. Referring to FIG. 1, an image processing system 1 includes an MFP (Multi-Function Peripheral) 100 that functions as an image processing apparatus, and personal computers (hereinafter referred to as PCs) 200, 200A, and 200B that remotely operate MFP 100, all of which are connected to a network 2.

Network 2 is a local area network (LAN) and connected to the Internet through a gateway. The form of connection of network 2 can be either wire or radio. Also, network 2 is not limited to LAN but can be a network using a public switched telephone network (PSTN), a wide area network (WAN), or the Internet.

PCs 200, 200A, and 200B are usual computers each installing a browsing program for downloading Web pages stored in a Web server. PCs 200, 200A, and 200B have the same structures and functions, and PC 200 will be taken as an example here unless stated otherwise.

MFP 100 includes a scanner for reading a document, and an image forming device and a facsimile device for forming an image onto a recording medium such as a sheet of paper based on image data, so that MFP 100 has an image reading function, a copying function, and a facsimile transmitting/receiving function. Also MFP 100 installs a program to cause it to function as a Web server. While MFP 100 is exemplified in this embodiment, some other apparatus functioning as a Web server may be used such as a printer, a facsimile, and a personal computer, instead of MFP 100.

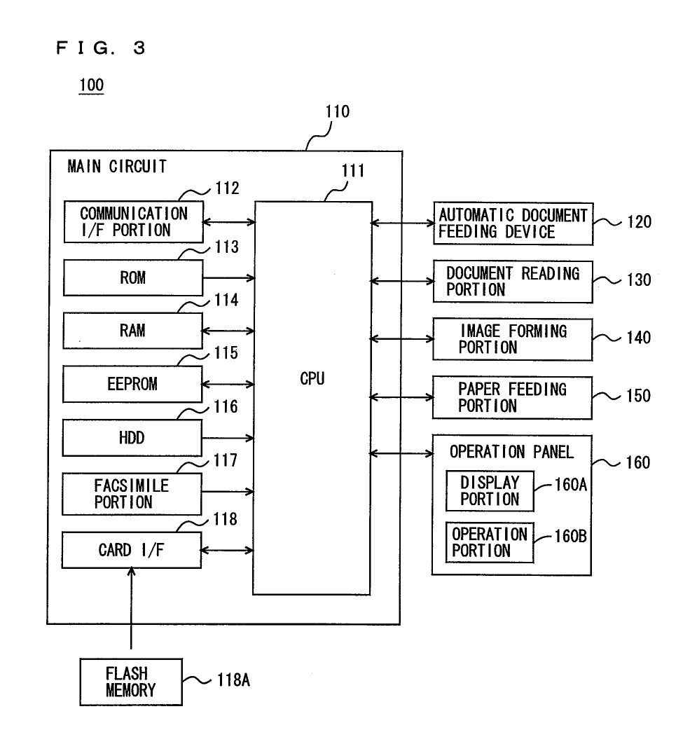

FIG. 2 is a perspective view of the MFP. FIG. 3 is a block diagram showing an example of the hardware structure of the MFP. Referring to FIGS. 2 and 3, MFP 100 includes a main circuit 110, a document reading portion 130 to read a document, an automatic document feeding device 120 to feed a document to document reading portion 130, an image forming portion 140 to form a static image onto a medium such as a sheet of paper when the static image read from the document is output from document reading portion 130, a paper feeding portion 150 to supply sheets to image forming portion 140, and an operation panel 160 serving as a user interface. Main circuit 110 includes a CPU 111, a communication interface (I/F) portion 112, a ROM 113, a RAM 114, an EEROM (Electronically Erasable and Programmable ROM) 115, a hard disk drive (HDD) 116 serving as a mass storage, a facsimile portion 117, and a card interface (I/F) 118 to which a flash memory 118A is mounted. CPU 111 is connected to automatic document feeding device 120, document reading portion 130, image forming portion 140, paper feeding portion 150, and operation panel 160, in order to generally control MFP 100.

ROM 113 stores a program executed by CPU 111 or data necessary for execution of the program. RAM 114 is used as a working area for CPU 111 to execute the program. Also RAM 114 temporarily stores static images continuously transmitted from document reading portion 130.

Operation panel 160 is provided on top of MFP 100 and includes a display portion 160A and an operation portion 160B. Display portion 160A is a display device such as a liquid crystal display (LCD) and an organic ELD (Electroluminescence Display), and displays, for example, an instruction menu for users and information about image data that is obtained. Operation portion 160B has a plurality of keys and accepts various instructions and characters and numbers input by user's operations. Also operation portion 160B includes a touch panel provided over display portion 160A.

Communication I/F portion 112 is an interface for connecting MFP 100 to network 2. CPU 111 communicates with PCs 200, 200A, and 200B through communication I/F portion 112 to exchange data. Also communication I/F portion 112 is communicable with computers connected to the Internet through network 2.

Facsimile portion 117 is connected to a PSTN (Public Switched Telephone Network) to transmit facsimile data to the PSTN or receive facsimile data from the PSTN. Facsimile portion 117 stores the received facsimile data in HDD 116 or outputs the received facsimile data to image forming portion 140. Image forming portion 140 prints the facsimile data received by facsimile portion 117 onto a sheet of paper. Facsimile portion 117 also converts output data read from a document by document reading portion 130 or data stored in HDD 116 into facsimile data, and transmits the facsimile data to the facsimile device connected to the PSTN.

To card I/F 118 is mounted flash memory 118A. CPU 111 is accessible to flash memory 118A through card I/F 118. CPU 111 loads into RAM 114 a program recorded in flash memory 118A mounted in card I/F 118 and executes the program. The program executed by CPU 111 is not limited to those recorded in flash memory 118A; CPU 111 may execute a program stored in HDD 116 by loading the program into RAM 114. In this case, any of the other terminals connected to network 2, i.e., PCs 200, 200A, and 200B, may rewrite the program stored in HDD 116 of MFP 100 or add and write a new program. It is also possible that MFP 100 downloads a program from any of the other terminals, PCs 200, 200A, and 200B, connected to network 2 and stores the program in HDD 116. The program, as used herein, not only includes a program directly executable by CPU 111, but also a source program, a compressed program, an encrypted program, and the like.

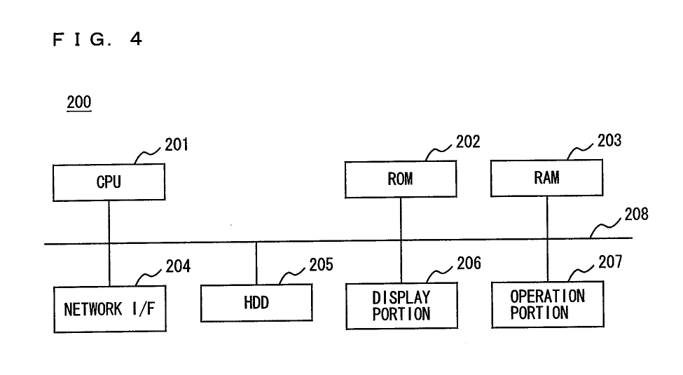

FIG. 4 is a block diagram showing an example of the hardware structure of the PC. Referring to FIG. 4, PC 200 includes a CPU 201 to generally control PC 200, a ROM 202 that stores a program or the like to be executed at CPU 201, a RAM 203 used as a working area for CPU 201, a network I/F 204 to connect PC 200 to a network, an HDD 205 serving as a mass storage, a display portion 206, and an operation portion 207 to accept input of operations from users.

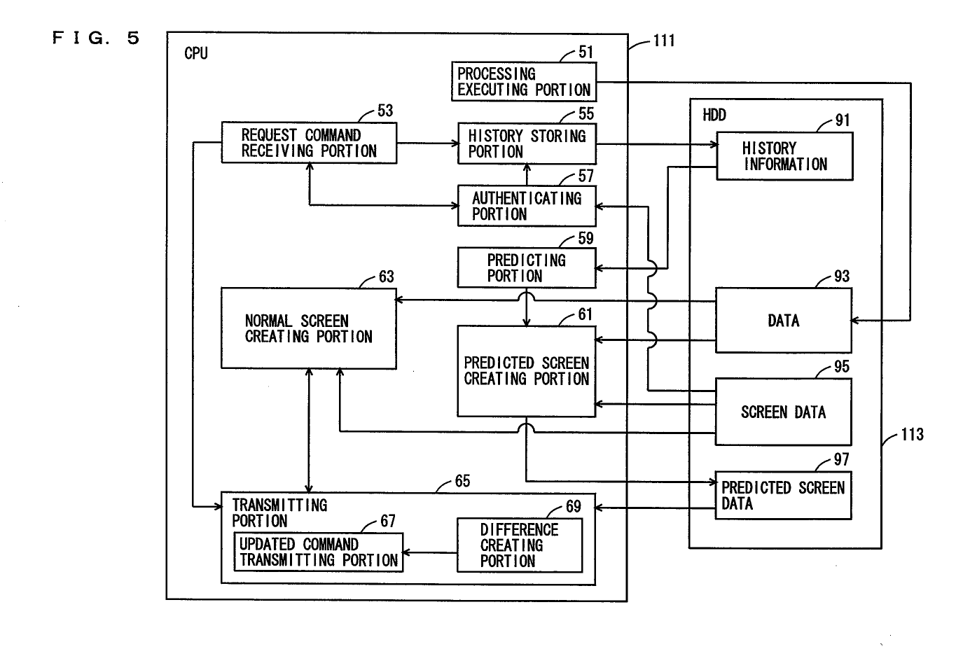

FIG. 5 is a functional block diagram showing an example of the functions of the CPU of the MFP together with data to be stored in the HDD. Referring to FIG. 5, CPU 111 of MFP 100 includes a processing executing portion 51 to execute processing, a request command receiving portion 53 to accept a request command, an authenticating portion 57 to authenticate users, a history storing portion 55 to store history information, a predicting portion 59 to predict a next request command based on the history information, a predicted screen creating portion to create a predicted screen in accordance with the predicted command, a normal screen creating portion to create a screen in accordance with the request command, and a transmitting portion to transmit screens.

HDD 116 stores in advance data 93 and screen data 95. Data 93 is stored in HDD 116 by processing executing portion 51 by executing processing. Data 93 includes image data stored in HDD 116. For example, when processing executing portion 51 causes document reading portion 130 to read a document and stores in HDD 116 image data output from document reading portion 130, processing executing portion 51 stores the image data received from document reading portion 130 in HDD 116 as data 93. Data 93 also includes a job history that indicates execution of processing by processing executing portion 51. The job history includes processing identification information (job number) for identifying processing executed by processing executing portion 51, an execution result, data identification information (document name) for specifying data that was subjected to processing, and the time when the processing was executed.

Screen data 95 includes a plurality of Web pages described in a markup language. The plurality of Web pages include a predetermined fixed screen and a processed screen including processed data obtained by processing data 93. The fixed screen includes a log-in screen and a menu screen in this embodiment. The menu screen is intended as a home page in this embodiment.

The log-in screen is a Web page for authenticating the authorization to remotely operate MFP 100 and accepts input of authentication information composed of user identification information and a password. The menu screen includes a plurality of choices for displaying the plurality of Web pages, and the plurality of choices are each associated with a URL for a link to one of the Web pages through a hyperlink defined by a tag. When any of the plurality of choices is selected on the menu screen, a request command requesting transmission of a Web page linked to the selected choice is transmitted. The request command includes a URL assigned to the Web page linked to the selected choice.

The processed screen is a Web page created by a program activated by what is called a CGI (Common Gateway Interface) and includes a file list screen and a job list screen in this embodiment. The file list screen and the job list screen include processed data created by processing data 93.

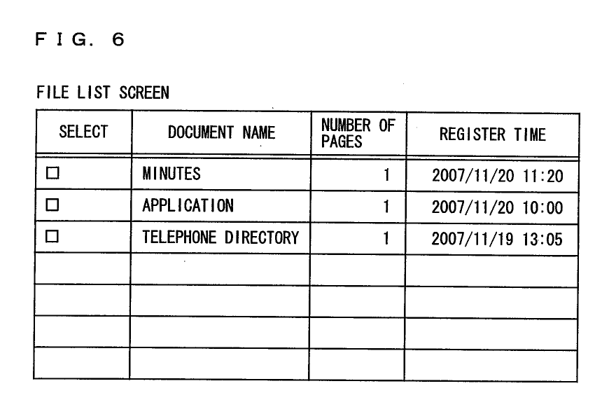

FIG. 6 is a diagram showing an example of the file list screen. The file list screen is a screen to display a list of the file names of data stored in storage areas (hereinafter referred to as “boxes”) of HDD 116. Different names are displayed corresponding to the boxes to be displayed.

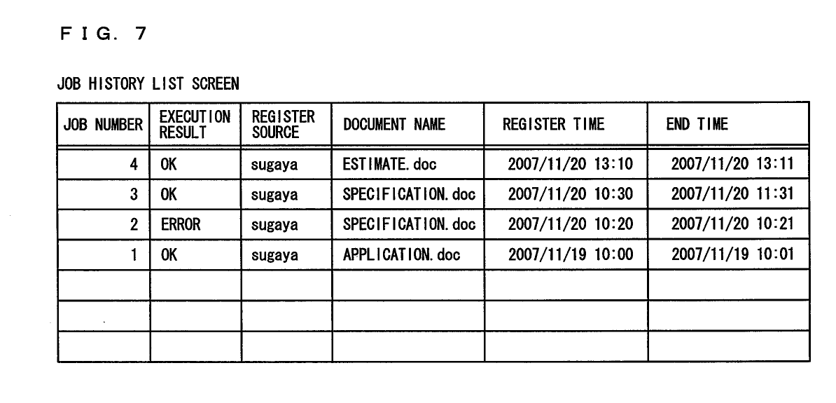

FIG. 7 is a diagram showing an example of the job list screen. The job list screen is a Web page to show a history of executed jobs and includes a list of names of the executed jobs. Different job names are displayed corresponding to the jobs that were executed.

Referring back to FIG. 5, when communication I/F portion 112 receives a request command from any of PCs 200, 200A, and 200B, which are connected to network 2, then request command receiving portion 53 accepts the request command from communication I/F portion 112. The request command is received in a HTTP protocol in this embodiment. The request command is one of a plurality of predetermined request commands.

Request command receiving portion 53, when receiving a request command requesting home page transmission, outputs the request command to a transmitting portion 65 on condition that an authentication signal is input from authenticating portion 57. When receiving a request command other than the request command requesting home page transmission, request command receiving portion 53 outputs the received request command and the user identification information of the user who has instructed transmission of the request command to history storing portion 55 and transmitting portion 65.

More specifically, when the user remotely operates MFP 100 on PC 200, PC 200 transmits to MFP 100 a request command requesting home page transmission. When communication I/F portion 112 receives the request command requesting home page transmission from PC 200, request command receiving portion 53 outputs the request command received from communication I/F portion 112 to authenticating portion 57.

Authenticating portion 57 reads the log-in screen from screen data 95 stored in HDD 116 and outputs the log-in screen to PC 200, which has transmitted the request command, through communication I/F portion 112. In this case, when the user of PC 200 inputs thereto authentication information composed of user identification information for identifying the user and a password in accordance with the log-in screen displayed on PC 200, then PC 200 executes a command included in the log-in screen so as to transmit the user identification information and the password to MFP 100.

Authenticating portion 57 determines whether to authenticate the user by judging whether HDD 116 stores in advance the same combination as the combination of the user identification information and the password that communication I/F portion 112 has received. HDD 116 stores in advance combinations of pieces of user identification information and passwords of users who are authorized to remotely operate MFP 100. When HDD 116 stores the same combination as the combination of the user identification information and the password that communication I/F portion 112 has received, then authenticating portion 57 authenticates the user but does not when the combination is not stored. When not authenticating the user, authenticating portion 57 transmits an error screen stored in advance in HDD 116 to PC 200, which has transmitted the request command, through communication I/F portion 112. When authenticating the user, authenticating portion 57 outputs an authentication signal to request command receiving portion 53 while outputting the user identification information to history storing portion 55.

History storing portion 55, upon input of the request command from request command receiving portion 53, creates a history record that combines the request command with the user identification information input from authenticating portion 57, and stores the history record by adding it to history information 91 stored in HDD 116. That is, every time an authenticated user remotely operates MFP 100, HDD 116 stores a history record that associates the request command for identifying the remote operation with the user identification information of the user.

Predicting portion 59 determines one of a plurality of request commands as a predicted command based on history information 91 stored in HDD 116 on a user identification information basis, and outputs a combination of the user identification information and the determined predicted command to a predicted screen creating portion 61. Specifically, predicting portion 59 classifies the history records stored in history information 91 stored in HDD 116 on a user identification information basis, and determines as a predicted command a request command among the request commands included in the history records classified on a user identification information basis when this request command satisfies any of the following conditions. Which condition to use to determine the predicted command may be determined in advance. (1) The request command is included in the last-stored history record among the classified history records. (2) As a result of a count of the history records, the request command is among the identical request commands having the largest count. (3) The screen created from the request command has the largest data volume among the request commands included in the classified history records.

Predicting portion 59 determines a predicted command on a user identification information basis and outputs the combination of the user identification information and the predicted command to predicted screen creating portion 61. The timing of predicting portion 59 to determine the predicted command may be determined in advance, examples including the time when power to MFP 100 is on, and every one week or one month.

In accordance with the combination of the user identification information and the predicted command input from predicting portion 59, predicted screen creating portion 61 creates a predicted screen and stores it in HDD 116. Then predicted screen creating portion 61 creates a predicted screen record associating the user identification information, the predicted command, and the stored predicted screen with each other, and updates predicted screen data 97 stored in HDD 116. Predicted screen data 97 includes the predicted screen record associating the user identification information, the predicted command, and the stored predicted screen with each other.

Also predicted screen creating portion 61 updates the predicted screen when processing executing portion 51 executes processing to update data 93. The screen modified by updating data 93 is a processed screen. Description will be made of the cases where the predicted screen is a job list screen or a file list screen serving as a processed screen.

When processing executing portion 51 executes processing, a job history is added to data 93. The job history includes user identification information. When HDD 116 stores a predicted screen record that includes the user identification information included in the added job history and a request command for creating job list screen, then predicted screen creating portion 61 creates a new job list screen based on the user identification information and the request command for creating job list screen, and updates the predicted screen stored in HDD 116 to associate the predicted screen with the created job list screen. Then predicted screen creating portion 61 updates a predicted screen associated with a predicted screen record, among the predicted screen records included in predicted screen data 97 stored in HDD 116, that includes the user identification information and a predicted command identical to the request command for creating the job list screen. The update is carried out in such a manner that the predicted screen is associated with the newly created job list screen.

When processing executing portion 51 executes processing and data 93 stored in HDD 116 undergoes addition, modification, or deletion, then data 93 is updated. Predicting portion 59 determines a request command for creating file list screen as a predicted screen. Each of the boxes in HDD 116 is associated with a different piece of user identification information. When HDD 116 stores a predicted screen record that includes user identification information associated with the box that stores the updated data and the request command for creating file list screen, then predicted screen creating portion 61 creates a new file list screen based on the user identification information and the request command for creating file list screen, and updates the predicted screen stored in HDD 116 to associate the predicted screen with the created file list screen. Then predicted screen creating portion 61 updates a predicted screen associated with a predicted screen record, among the predicted screen records included in predicted screen data 97 stored in HDD 116, that includes the user identification information and a predicted command identical to the request command for creating the file list screen. The update is carried out in such a manner that the predicted screen is associated with the newly created file list screen.

Thus, while data 93 stored in HDD 116 is updated every time processing executing portion 51 executes processing, a predicted screen is created every time data 93 is updated, thereby updating predicted screen data 97. This keeps the predicted screen abreast of the latest status.

Transmitting portion 65, upon input of a request command from request command receiving portion 53, transmits a screen that corresponds to the request command to any of PCs 200, 200A, and 200B that has transmitted the request command. Specifically, when a request command requesting home page transmission is input from request command receiving portion 53, then transmitting portion 65 makes a request for a home page to a normal screen creating portion 63 and acquires the home page therefrom. Then transmitting portion 65 transmits the acquired home page to any of PCs 200, 200A, and 200B that has transmitted the request command.

Also transmitting portion 65, upon input of a request command and user identification information from request command receiving portion 53, extracts a predicted screen record that includes the request command and the user identification information from predicted screen data 97 stored in HDD 116. When the predicted screen record that includes the request command and the user identification information input from request command receiving portion 53 is extracted, transmitting portion 65 reads from HDD 116 a predicted screen associated with this predicted screen record and transmits the predicted screen to any of PCs 200, 200A, and 200B that has transmitted the request command. When no predicted screen record that includes the request command and the user identification information input from request command receiving portion 53 is extracted, transmitting portion 65 outputs to normal screen creating portion 63 a screen creating instruction including the request command and the user identification information input from request command receiving portion 53, and acquires a processed screen from normal screen creating portion 63. Transmitting portion 65 transmits the acquired processed screen to any of PCs 200, 200A, and 200B that has transmitted the request command.

Normal screen creating portion 63, upon request for a home page from transmitting portion 65, reads a menu screen, which serves as the home page, from among image data 95 stored in HDD 116, and outputs the menu page to transmitting portion 65. When the screen creating instruction is input from transmitting portion 65, normal screen creating portion 63 causes the CGI to activate a predetermined program and creates a processed screen in accordance with the combination of the user identification information and the request command included in the screen creating instruction. Specifically, normal screen creating portion 63 creates a processed screen that includes processed data into which data 93 is processed, and outputs the created processed screen to transmitting portion 65.

Transmitting portion 65 includes a difference creating portion 69 and an updated command transmitting portion 67. When data 93 is updated after transmitting portion 65 has transmitted the predicted screen, predicted screen creating portion 61 creates a new predicted screen and HDD 116 stores the newly created predicted screen. Difference creating portion 69 creates a difference between the previously transmitted predicted screen and the newly created predicted screen and outputs the difference to updated command transmitting portion 67.

Transmitting portion 65 stores combinations of user identification information and predicted commands input from request command receiving portion 53. When an input combination is the same as the previously input combination, transmitting portion 65 does not output a creating instruction to normal screen creating portion 63 but outputs a difference transmitting instruction to updated command transmitting portion 67. Updated command transmitting portion 67 transmits, to any of PCs 200, 200A, and 200B that has transmitted the request command, the difference created by difference creating portion 69 and a command to create a new screen from the previously transmitted predicted screen and the difference created by difference creating portion 69 and display the new screen. Since updated command transmitting portion 67 transmits only a difference instead of transmitting the predicted screen, the amount of data to be transmitted is reduced.

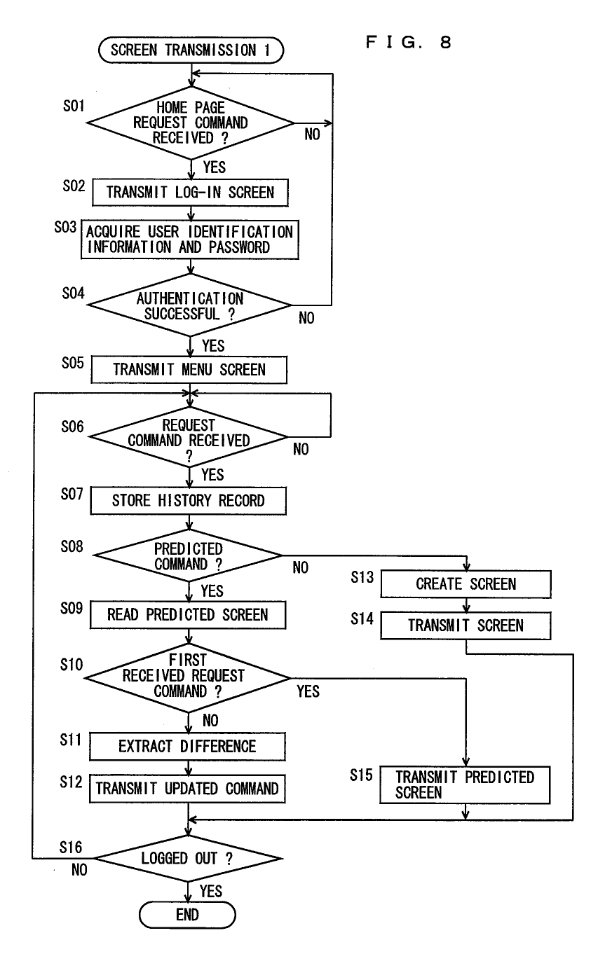

FIG. 8 is a flowchart showing an example of the flow of screen transmission processing. The screen transmission processing is executed by CPU 111 of MFP 100 when CPU 111 executes a screen transmission program. Referring to FIG. 8, CPU 111 judges whether a request command requesting home page transmission has been received (step S01). CPU 111 turns into a stand-by state until communication I/F portion 112 receives a request command requesting home page transmission (“NO” in step S01). When communication I/F portion 112 receives a request command requesting home page transmission from any of PCs 200, 200A, and 200B (“YES” in step S01), the processing proceeds to step S02. Description will be made of the case where the request command is received from PC 200.

In step S02, CPU 111 transmits a log-in screen to PC 200, which has transmitted the request command. Then CPU 111 acquires user identification information and a password transmitted from PC 200 (step S03), and authenticates them (step S04). The authentication is successful when HDD 116 stores in advance the combination of the user identification information and the password acquired in step S03. When the authentication is successful, the processing proceeds to step S05, while when the authentication is unsuccessful the processing returns to step S01. In step S05, CPU 111 transmits a menu screen, which serves as the home page, to PC 200, which has transmitted the request command.

In the next step S06, CPU 111 turns into a stand-by state until reception of a request command (“NO” in step S06). When a request command is received (“YES” in step S06), the processing proceeds to step S07. In step S07, CPU 111 creates a history record and stores it in HDD 116. Specifically, CPU 111 creates a history record including the user identification information acquired in step S03 and the request command received in step S06, and stores the history record by adding it to history information 91 stored in HDD 116.

In the next step S08, CPU 111 judges whether the request command received in step S06 is the same as a predicted command. Specifically, CPU 111 judges that the request command and the predicted command are the same when CPU 111 extracts a predicted screen record, among the predicted screen records included in predicted screen data 97 stored in HDD 116, that includes the user identification information acquired in step S03 and a predicted command identical to the request command received in step S06, while when no such predicted screen record is extracted, CPU 111 judges that the request command and the predicted command are different. When the request command and the predicted command are the same, the processing proceeds to step S09, while otherwise the processing proceeds to step S13.

In step S09, CPU 111 reads from HDD 116 a predicted screen associated with the predicted screen record extracted in step S08. In the next step S10, CPU 111 judges whether the request command received in step S06 is the first request command. When the same request commands are received at least two times, the processing proceeds to step S11, while otherwise the processing proceeds to step S15. In step S15, CPU 111 transmits the predicted screen read in step S09 and proceeds the processing to step S16.

In step S11, CPU 111 extracts a difference between the predicted screen transmitted in the previously executed step S15 and the predicted screen read in step S09. This is because the previously transmitted predicted screen may be updated by predicted screen management processing, described later. Then CPU 111 transmits an updated command to PC 200, which has transmitted the request command (step S12). The updated command includes the difference extracted in step S11 and a command to update the predicted screen based on the difference and the previously transmitted predicted screen and display the updated predicted screen. When there is no difference, the updated command includes “0” as the difference and a command to display the previously transmitted predicted screen.

When the request command and the predicted command are different, the processing proceeds to step S13. In this case, CPU 111 creates a new screen based on the user identification information acquired in step S03 and the request command received in step S06 (step S13). Then CPU 111 transmits the newly created screen to PC 200, which has transmitted the request command (step S14), and proceeds the processing to step S16.

In step S16, CPU 111 judges whether the user authenticated in step S04 logged out. When the session with PC 200 is disconnected, CPU 111 judges that the user logged out. When judging that the user logged out, CPU 111 discontinues the processing while otherwise returns the processing to step S06.

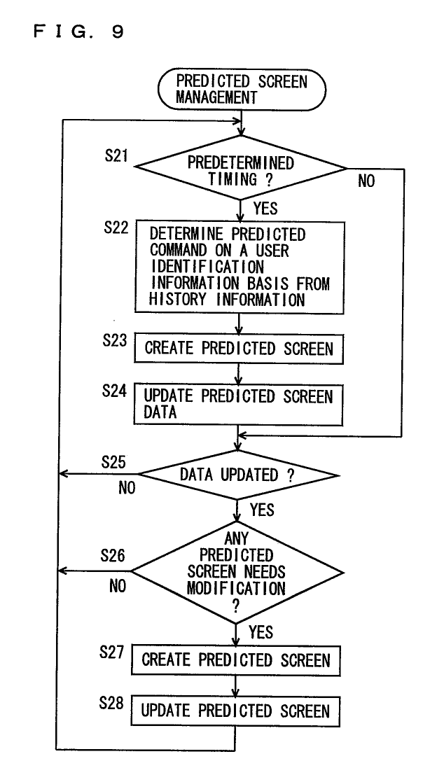

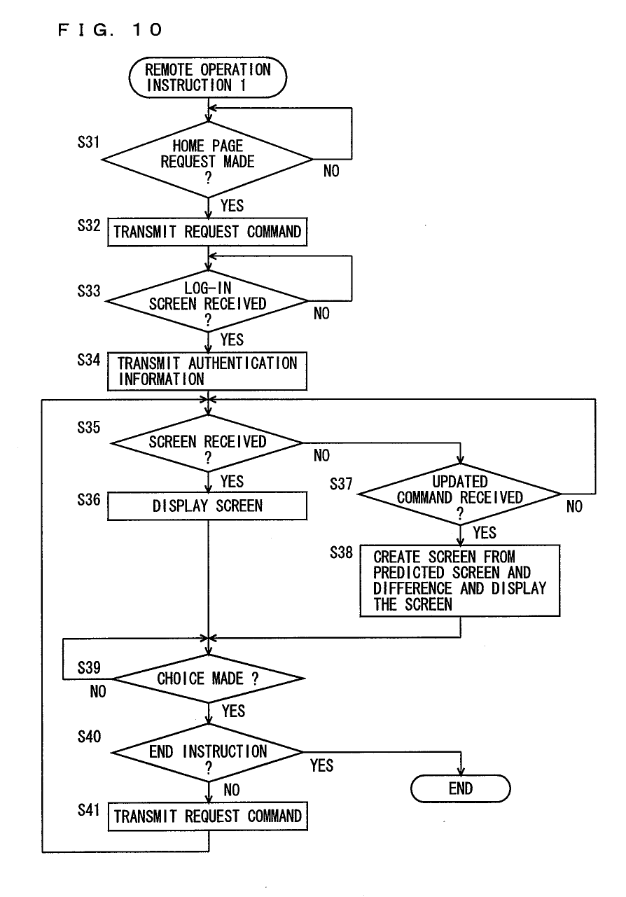

FIG. 9 is a flowchart showing an example of the flow of predicted screen management processing. The predicted screen management processing is executed by CPU 111 of MFP 100 when CPU 111 executes a predicted screen management program. Referring to FIG. 9, CPU 111 judges whether a predetermined timing has come (step S21). The predetermined timing may be determined in advance, examples including the time when power to MFP 100 is on, and every one week or one month. When the predetermined timing has come, the processing proceeds to step S22, while otherwise the processing proceeds to step S24.

In step S22, CPU 111 determines, based on history information 91 stored in HDD 116, one of a plurality of request commands as a predicted command on a user identification information basis. Specifically, CPU 111 classifies the history records stored in history information 91 stored in HDD 116 on a user identification information basis, and determines as a predicted command a request command, among the request commands included in the history records classified on a user identification information basis, that is among the identical request commands having the largest count as a result of a count of the history records. Alternatively, the predicted command may be a request command that is included in the last-stored history record, or a request command, among the request commands included in the classified history records, that involves a screen having the largest data volume.

In step S23, CPU 111 creates a predicted screen on a user identification information basis in accordance with the determined predicted command. Then CPU 111 updates predicted screen data 97 stored in HDD 116 (step S24).

In step S25, CPU 111 judges whether data 93 stored in HDD 116 has been updated. When judging that data 93 has been updated, CPU 111 proceeds the processing to step S26 while otherwise returns the processing to step S21. In step S26, CPU 111 judges whether there is a predicted screen that needs modification. When there is a predicted screen that needs modification due to update of data 93, the processing proceeds to step S27, while when there is no such predicted screen the processing returns to step S21. Since every predicted screen includes data into which data 93 is processed, there is a case of existence of a predicted screen that needs modification due to update of data 93.

In step S27, CPU 111 creates a new predicted screen to replace the predicted screen that needs modification. Then CPU 111 uses the created predicted screen to update the predicted screen stored in HDD 116 (step S28), and returns the processing to step S21. The update of the predicted screen is carried out in such a manner that the predicted screen record associated with the pre-updated predicted screen is associated with the updated predicted screen.

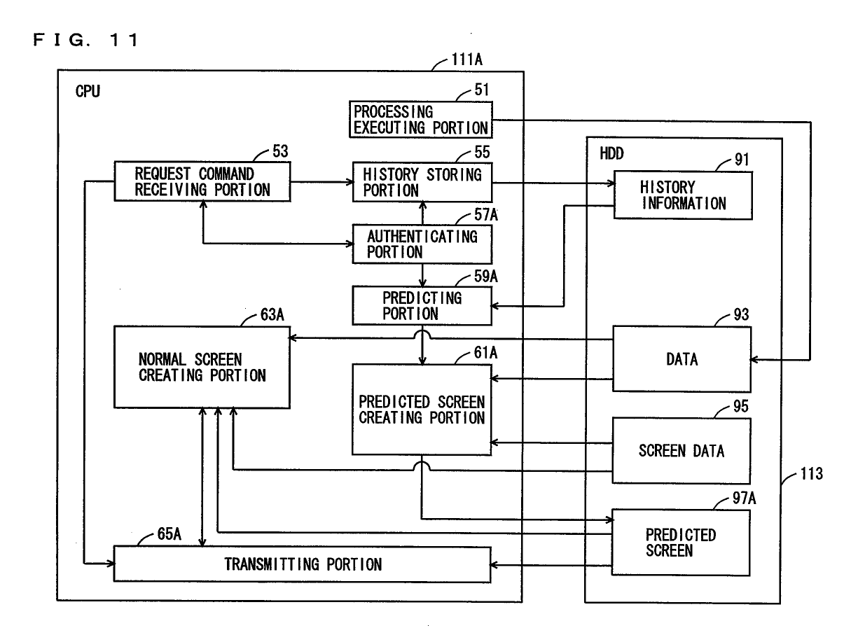

FIG. 10 is a flowchart showing an example of the flow of remote operation instruction processing. The remote operation instruction processing is executed by CPU 201 of each of PCs 200, 200A, and 200B when CPU 201 executes a browsing program. Referring to FIG. 10, CPU 201 turns into a stand-by state until reception of a home page request (step S31), and proceeds the processing to step S32 upon reception of a request for the home page of, in this embodiment, MFP 100. CPU 111 accepts the home page request upon input of the URL of the home page, which is the menu screen in this embodiment, stored in MFP 100.

In step S32, CPU 201 transmits to MFP 100 a request command requesting home page transmission. CPU 201 turns into a stand-by state until reception of a log-in screen (“NO” in step S33). Upon reception of a log-in screen (“YES” in step S33), CPU 201 proceeds the processing to step S34.

In step S34, CPU 201 accepts authentication information and transmits it to MFP 100. The authentication information includes user identification information and a password. Then CPU 201 judges whether a screen has been received from MFP 100. When a screen is received, the processing proceeds to step S36, while otherwise the processing proceeds to step S37. In step S36, CPU 201 displays the screen received in step S35 and proceeds the processing to step S39.

In step S37, CPU 201 judges whether an updated command has been received. When an updated command is received, the processing proceeds to step S38, while otherwise the processing returns to step S35. The updated command includes a modification (difference) made to a previously received predicted screen and a command to create a new screen from the previously received predicted screen and the difference and display the new screen. In step S38, CPU 201 creates a new screen from the predicted screen and the difference in accordance with the command included in the updated command and displays the new screen, and proceeds the processing to step S39.

In step S39, CPU 201 turns into a stand-by state until reception of a choice that instructs choice of an option included in the displayed screen (“NO” in step S39). Upon reception of a choice (“YES” in step S39), CPU 201 proceeds the processing to step S40. When the chosen option indicates an end instruction (“YES” in step S40), CPU 201 ends the processing while otherwise (“NO” in step S40) proceeds the processing to step S41. In step S41, CPU 201 transmits to MFP 100 a request command associated with the chosen option and returns the processing to step S35.

As has been described above, MFP 100 according to the present invention creates, upon externally receiving one of a plurality of predetermined request commands, a history record including the received request command and user identification information, and stores the history record by adding it to history information 91 in HDD 116. Then MFP 100 determines a predicted command based on the stored history information 91 and creates a predicted screen in accordance with the predicted command. When the predicted command is the same as a next-received request command, MFP 100 transmits the predicted screen. Thus, the predicted screen is already created before reception of a request command that is identical to the predicted command. This saves the time required for creating the predicted screen and shortens the time between reception of the request command and transmission of screen.

The predicted screen is a processed screen including data into which stored data is processed, which shortens the time required for aggregating or analyzing data.

The predicted screen is created when data 93 is updated, which enables transmission of a screen created based on the latest data.

When the data is updated after transmission of the predicted screen, a newly created predicted screen is not transmitted but a difference between the already transmitted predicted screen and the newly created predicted screen is transmitted, which reduces the amount of data to be transmitted.

The predicted command is determined based on history information that includes the user identification information of the user who has transmitted the request command, which enables transmission of a different predicted screen depending on the user.

### Modified Example

While MFP 100 according to the above embodiment creates in advance a predicted screen based on history information 91 on a user identification information basis and stores the predicted screen in HDD 116, an MFP 100A according a modified example creates a predicted screen upon log-in of a user for remote operation and transmits the predicted screen in advance. Description will be made of respects in which MFP 100A differs from MFP 100.

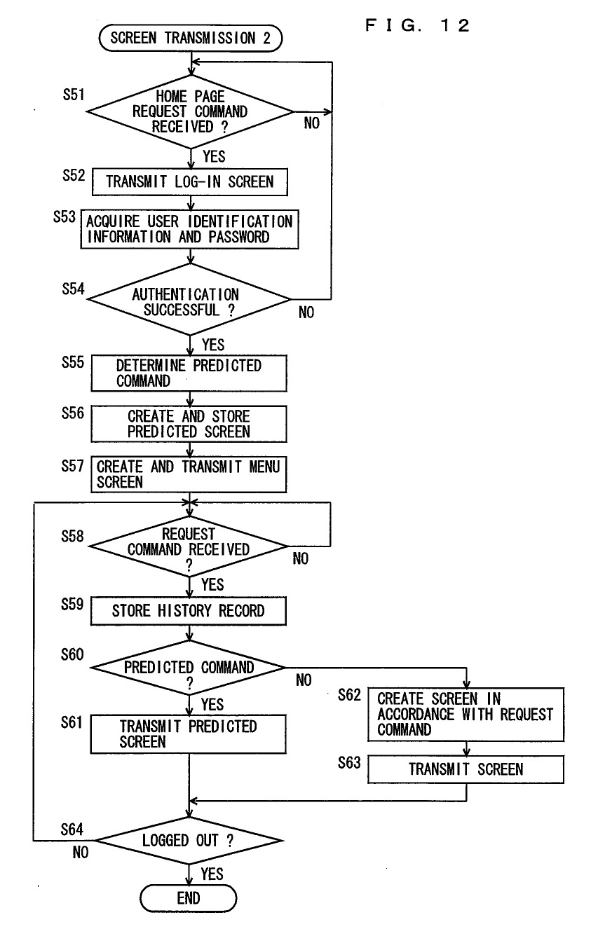

FIG. 11 is a schematic functional block diagram showing the functions of CPU 111A of MFP 100A according to the modified example. Referring to FIG. 11, this functional block diagram differs from that in FIG. 5 in that authenticating portion 57 is changed to an authenticating portion 57A, predicting portion 59 to a predicting portion 59A, predicted screen creating portion 61 to a predicted screen creating portion 61A, normal screen creating portion 63 to a normal screen creating portion 63A, and transmitting portion 65 to a transmitting portion 65A, and that HDD 116 stores a predicted screen 97A instead of predicted screen data 97.

Authenticating portion 57A judges whether to authenticate a user based on a combination of user identification information and a password received by communication I/F portion 112. When the user is authenticated, authenticating portion 57A outputs an authentication signal to request command receiving portion 53 and outputs the user identification information to history storing portion 55 and predicting portion 59A.

Predicting portion 59A, upon input of the user identification information from authenticating portion 57A, extracts history records, among the history records included in history information 91 stored in HDD 116, that include the user identification information input from authenticating portion 57A. Then predicting portion 59A determines as a predicted command one of a plurality of request commands based on the extracted history records, and outputs the determined predicted command to predicted screen creating portion 61A. Specifically, predicting portion 59A determines as a predicted command a request command among the request commands included in the extracted history records when this request command satisfies any of the following conditions. Which condition to use to determine the predicted command may be determined in advance. (1) The request command is included in the last-stored history record among the extracted history records. (2) As a result of a count of the history records, the request command is among the identical request commands having the largest count. (3) The screen created from the request command has the largest data volume among the request commands included in the extracted history records.

Predicted screen creating portion 61A creates predicted screen 97A in accordance with the predicted command input from predicting portion 59A and the user identification information authenticated by authenticating portion 57A, and stores predicted screen 97A in HDD 116.

Transmitting portion 65A, upon input of a request command from request command receiving portion 53, transmits a screen that corresponds to the request command to any of PCs 200, 200A, and 200B that has transmitted the request command. Specifically, when a request command requesting home page transmission is input from request command receiving portion 53, then transmitting portion 65A makes a request for a home page to normal screen creating portion 63A and acquires the home page therefrom. Then transmitting portion 65A transmits the acquired home page to any of PCs 200, 200A, and 200B that has transmitted the request command.

Normal screen creating portion 63A, upon request for a home page from transmitting portion 65A, reads a menu screen, which serves as the home page, from among image data 95 stored in HDD 116, and embeds commands in the menu screen, the commands including: a command to transmit the predicted command; a command to, when a predicted screen is received, temporarily store the predicted screen instead of displaying it; and a command to, when transmitting the same request command as the predicted command, display the temporarily stored predicted screen instead of transmitting the request command. Then normal screen creating portion 63A outputs the command-embedded menu screen to transmitting portion 65A. The command to transmit the predicted command includes the URL of predicted screen 97A stored in HDD 116.

Upon input of a request command other than the request command requesting home page transmission from request command receiving portion 53, transmitting portion 65A judges whether HDD 116 stores a screen corresponding to this request command as predicted screen 97A. When HDD 116 stores a screen corresponding to the request command as predicted screen 97A, transmitting portion 65A reads this predicted screen 97A and transmits it to any of PCs 200, 200A, and 200B that has transmitted the request command. When HDD 116 stores no screens corresponding to the request command as predicted screen 97A, transmitting portion 65A outputs to normal screen creating portion 63A a screen creating instruction including the request command and user identification information input from request command receiving portion 53, and acquires a processed screen from normal screen creating portion 63A. Transmitting portion 65A transmits the acquired processed screen to any of PCs 200, 200A, and 200B that has transmitted the request command.

When the screen creating instruction is input from transmitting portion 65A, normal screen creating portion 63A creates a processed screen in accordance with the combination of the user identification information and the request command included in the screen creating instruction. Specifically, normal screen creating portion 63A creates a processed screen including processed data into which data 93 is processed and outputs the created processed screen to transmitting portion 65A.

While in the modified example transmitting portion 65A does not include difference creating portion 69 and updated command transmitting portion 67, transmitting portion 65A may include difference creating portion 69 and updated command transmitting portion 67.

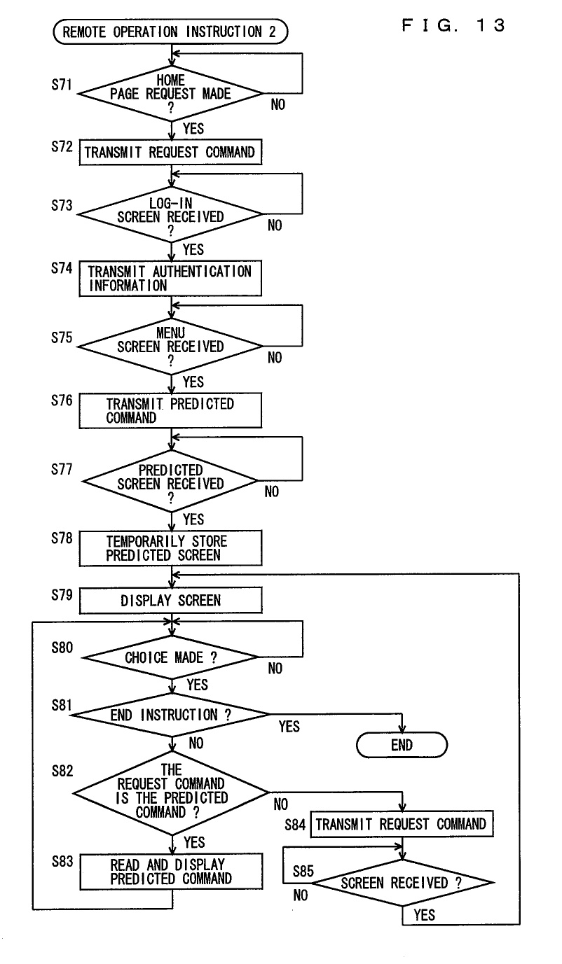

FIG. 12 is a flowchart showing an example of the flow of screen transmission processing according to the modified example. The screen transmission processing according to the modified example is executed by CPU 111A of MFP 100A according to the modified example when CPU 111A executes a screen transmission program. Referring to FIG. 12, steps S51 to S54 are respectively the same as steps S01 to S04 in the screen transmission processing shown in FIG. 8, and thus description thereof will not be repeated. When authentication is successful in step S54, then in step S55, CPU 111A determines as a predicted command one of a plurality of request commands based on history information 91 stored in HDD 116. Specifically, CPU 111A extracts history records, from among the history records stored in history information 91 stored in HDD 116, that include user identification information acquired in step S53, and determines as a predicted command a request command that is among the identical request commands having the largest count as a result of a count of the history records. Alternatively, the predicted command may be a request command that is included in the last-stored history record among the extracted history records, or a request command, among the request commands included in the extracted history records, that involves a screen having the largest data volume.

In step S56, CPU 111A creates a predicted screen in accordance with the user identification information acquired in step S53 and the predicted command determined in step S55, and stores the created predicted screen in HDD 116. Then CPU 111A creates and transmits a menu screen (step S56). Specifically, CPU 111A reads a menu screen stored in HDD 116 and creates a menu screen by embedding commands in the read menu screen, the commands including: a first command to transmit the predicted command; a second command to, when a predicted screen is received, temporarily store the predicted screen instead of displaying it; and a third command to, when transmitting the same request command as the predicted command, display the temporarily stored predicted screen instead of transmitting the request command. The predicted command includes the URL of the predicted screen stored in HDD 116 in step S56 and is a request command requesting transmission of the predicted screen.

In the next step S58, CPU 111A turns into a stand-by state until reception of a request command (“NO” in step S58). Upon reception of a request command (“YES” in step S58), CPU 111A proceeds the processing to step S59. In step S59, CPU 111A creates a history record and stores it in HDD 116. Specifically, CPU 111A creates a history record including the user identification information acquired in step S53 and the request command received in step S58, and stores the history record by adding it to history information 91 stored in HDD 116.

In the next step S60, CPU 111A judges whether the request command received in step S58 is the same as the predicted command. Specifically, CPU 111A judges whether the request command received in step S58 is the same as the predicted command for creating predicted screen 97A stored in HDD 116. When the request command is the same as the predicted command, the processing proceeds to step S61, while otherwise the processing proceeds to step S62.

In step S61, CPU 111A reads from HDD 116 predicted screen 97A stored in HDD 116 and transmits predicted screen 97A, and proceeds the processing to step S64. In step S62, CPU 111A creates a new screen based on the user identification information acquired in step S53 and the request command received in step S58. Then CPU 111A transmits the created screen to PC 200 (step S63), which has transmitted the request command, and proceeds the processing to step S64.

In step S54, CPU 111A judges whether the user authenticated in step S54 logged out. When the session with PC 200 is disconnected, CPU 111A judges that the user logged out. When judging that the user logged out, CPU 111A discontinues the processing while otherwise returns the processing to step S58.

FIG. 13 is a flowchart showing an example of the flow of remote operation instruction processing according to the modified example. The remote operation instruction processing is executed by CPU 201 of each of PCs 200, 200A, and 200B when CPU 201 executes a browsing program. Referring to FIG. 13, steps S71 to S74 are respectively the same as steps S31 to S34 in the remote operation instruction processing shown in FIG. 10, and thus description thereof will not be repeated.

After transmission of authentication information to MFP 100 in step S74, CPU 201 turns into a stand-by state until reception of a menu screen (“NO” in step S75). Upon reception of a menu screen (“YES” in step S75), CPU 201 proceeds the processing to step S76. The menu screen has embedded therein the first command to transmit the predicted command, the second command to, when a predicted screen is received, temporarily store the predicted screen instead of displaying it, and the third command to, when transmitting the same request command as the predicted command, display the temporarily stored predicted screen instead of transmitting the request command, and therefore CPU 201 executes the following processing in accordance with the first to third commands, upon reception of the menu screen.

In step S76, CPU 201 transmits the predicted screen by executing the first command. Then CPU 201 turns into a stand-by state until reception of the predicted screen (“NO” in step S77). Upon reception of the predicted screen (“YES” in step S77), CPU 201 temporarily stores the received predicted screen by executing the second command (step S78).

In the next step S79, CPU 201 displays the screen. When the processing proceeds from step S78 to step S79, CPU 201 displays the menu screen received in step S75. Then CPU 201 turns into a stand-by state until reception of a choice that instructs choice of an option included in the displayed screen (“NO” in step S80). Upon reception of a choice (“YES” in step S80), CPU 201 proceeds the processing to step S81. When the chosen option indicates an end instruction (“YES” in step S81), CPU 201 ends the processing while otherwise (“NO” in step S81) proceeds the processing to step S82. In step S82, CPU 201 judges whether a request command associated with the chosen option is the predicted screen. When the request command is the predicted command, CPU 201 executes the third command extracted from the menu screen received in step S75, and in step S83, reads and displays the predicted screen temporarily stored in step S78. Then CPU 201 proceeds the processing to step S80.

In step S84, CPU 201 transmits to MFP 100 the request command associated with the chosen option and proceeds the processing to step S85. In step S85, CPU 201 turns into a stand-by state until reception of a screen from MFP 100 (“NO” in step S85). Upon reception of a screen from MFP 100 (“ES” in step S85), CPU 201 returns the processing to step S79. In step S79, when the processing proceeds from S85, CPU 201 displays the screen received in step S85.

As has been described hereinbefore, MFP 100A according to the modified example embeds in the menu screen the first command to transmit the predicted command, the second command to, when a predicted screen is received, temporarily store the predicted screen instead of displaying it, and the third command to, when transmitting the same request command as the predicted command, display the temporarily stored predicted screen instead of transmitting the request command, and transmits the predicted screen immediately after transmitting the menu screen. This causes PC 200, when receiving the menu screen, to receive and store the predicted screen in advance, which eliminates the need for creating and transmitting a predicted screen 97A frequently requested by the user of PC 200 after a request is made, thus enabling an immediate display.

While CPU 111A according to the modified example embeds in the menu screen the first command to transmit the predicted command, the second command to, when a predicted screen is received, temporarily store the predicted screen instead of displaying it, and the third command to, when transmitting the same request command as the predicted command, display the temporarily stored predicted screen instead of transmitting the request command, and transmits the predicted screen immediately after transmitting the menu screen, CPU 111A may transmit the menu screen stored in HDD 116 instead of embedding the first to third commands in the menu screen. In this case, steps S76 to S78 and steps S82 and S83 in the remote operation instruction processing shown in FIG. 13 are not executed. When an end instruction is not accepted in step S81, the processing may proceed to step S84. In this case, since MFP 100 creates predicted screen 97A and stores it in HDD 116, when PC 200 transmits the predicted command, MFP 100 transmits the predicted screen stored in HDD 116. This saves MFP 100 the need to create the predicted screen after receiving the predicted command, thereby shortening the time required for creating the predicted screen.

While in the above embodiment description has been made of MFP 100 as the image processing apparatus, it will be readily appreciated that the present invention can also be taken as a screen transmission method for executing the processing shown in FIG. 8, FIG. 9, or FIG. 12, or as a screen transmission program for causing a computer to execute the screen transmission method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
a request command receiving portion to externally receive one of a plurality of predetermined request commands;
a history storing portion to store a piece of history information including said received request command;
a predicting portion to determine a predicted command among said plurality of request commands based on said stored piece of history information;
a predicted screen creating portion to create a predicted screen in accordance with said determined predicted command; and
a transmitting portion to transmit said predicted screen when a request command received by said request command receiving portion is the same as said predicted command.

2. The image processing apparatus according to claim 1, further comprising a data storing portion to store data,
wherein said predicted screen creating portion creates said predicted screen based on said stored data.

3. The image processing apparatus according to claim 2, wherein said predicted screen creating portion creates a predicted screen upon modification of said stored data.

4. The image processing apparatus according to claim 3, further comprising a difference creating portion to, when said stored data is modified after said transmitting portion has transmitted said predicted screen, create a difference between said predicted screen already transmitted by said transmitting portion and a predicted screen newly created by said predicted screen creating portion based on said modified data,
wherein when said predicted command is the same as a request command received by said request command receiving portion after said predicted screen has been transmitted, said transmitting portion transmits said created difference and a command to create a new screen from said already transmitted predicted screen and said created difference and display said new screen instead of said already transmitted predicted screen.

5. The image processing apparatus according to claim 1, wherein:
said history storing portion stores a piece of history information that associates said received request command with user identification information for identifying a user who has instructed said request command; and
upon reception of one of said plurality of request commands, said predicting portion determines said predicted command based on, among a plurality of pieces of stored history information, said piece of history information including said user identification information of said user who has instructed said received request command.

6. The image processing apparatus according to claim 5, further comprising a user identifying portion to identify said user who has instructed said received request command.

7. The image processing apparatus according to claim 1, further comprising an initial screen transmitting portion to transmit an initial screen including a first command to transmit said determined predicted command, a second command to, when said predicted screen is received, temporarily store said predicted screen instead of displaying said predicted screen, and a third command to, when the same request command as said predicted command is transmitted, display said temporarily stored predicted screen instead of transmitting said request command.

8. The image processing apparatus according to claim 7, wherein:
said predicting portion determines said predicted command upon acceptance of a predetermined request command among said plurality of request commands;
said predicted screen creating portion creates said predicted screen upon determination of said predicted command; and
said predicted command includes a piece of information about a location where said created predicted screen is stored.

9. The image processing apparatus according to claim 1, further comprising a screen creating portion to create a screen in accordance with said received request command,
wherein when a request command received by said request command receiving portion differs from said predicted command, said transmitting portion transmits said screen created by said screen creating portion.

10. The image processing apparatus according to claim 1, wherein said predicting portion determines said predicted command upon acceptance of a predetermined request command among said plurality of request commands.

11. A screen transmission method comprising steps of:
externally receiving one of a plurality of predetermined request commands;
storing a piece of history information including said received request command;
determining a predicted command among said plurality of request commands based on said stored piece of history information;
creating a predicted screen in accordance with said determined predicted command; and
transmitting said predicted screen when a request command is the same as said predicted command.

12. The screen transmission method according to claim 11, further comprising a step of storing data,
wherein said predicted screen creating step comprises a step of creating said predicted screen based on said stored data.

13. The screen transmission method according to claim 12, wherein said predicted screen creating step comprises a step of creating a predicted screen upon modification of said stored data.

14. The screen transmission method according to claim 13, further comprising a step of, when said stored data is modified after said predicted screen has been transmitted by said transmitting step, creating a difference between said predicted screen already transmitted by said transmitting step and a predicted screen newly created by said predicted screen creating step based on said modified data,
wherein said transmitting step comprises a step of, when said predicted command is the same as a request command received after said predicted screen has been transmitted, transmitting said created difference and a command to create a new screen from said already transmitted predicted screen and said created difference and display said new screen instead of said already transmitted predicted screen.

15. The screen transmission method according to claim 11, wherein:
said storing step comprises a step of storing a piece of history information that associates said received request command with user identification information for identifying a user who has instructed said request command; and
said predicting step comprises a step of, upon reception of one of said plurality of request commands, determining said predicted command based on, among a plurality of pieces of stored history information, said piece of history information including said user identification information of said user who has instructed said received request command.

16. The screen transmission method according to claim 15, further comprising identifying said user who has instructed said received request command.

17. The screen transmission method according to claim 11, further comprising a step of transmitting an initial screen including a first command to transmit said determined predicted command, a second command to, when said predicted screen is received, temporarily store said predicted screen instead of displaying said predicted screen, and a third command to, when the same request command as said predicted command is transmitted, display said temporarily stored predicted screen instead of transmitting said request command.

18. The screen transmission method according to claim 17, wherein:
said predicting step comprises a step of determining said predicted command upon reception of a predetermined request command among said plurality of request commands;
said predicted screen creating step comprises a step of creating said predicted screen upon determination of said predicted command; and
said predicted command includes a piece of information about a location where said created predicted screen is stored.

19. The screen transmission method according to claim 11, further comprising a step of creating a screen in accordance with said received request command,
wherein said transmitting step comprises a step of, when a request command received by said receiving step differs from said predicted command, transmitting said screen created by said screen creating step.

20. The screen transmission method according to claim 11, wherein said predicting step comprises a step of determining said predicted command upon acceptance of a predetermined request command among said plurality of request commands.

21. A screen transmission program embodied on a computer readable medium for causing a computer to execute processing including steps of:
externally receiving one of a plurality of predetermined request commands;
storing a piece of history information including said received request command;
determining a predicted command among said plurality of request commands based on said stored piece of history information;
creating a predicted screen in accordance with said determined predicted command; and
transmitting said predicted screen when a request command received by said receiving step is the same as said predicted command.
